(19) United States
(12) Patent Application Publication
(10) Pub. No.: US 2026/0233698 A1
(43) Pub. Date: Aug. 13, 2026

(54) SEAT BELT FEEDER AND VEHICLE INCLUDING THE SAME

(71) Applicants: Hyundai Motor Company, Seoul (KR); Kia Corporation, Seoul (KR); Daechang Seat Co., LTD-Dongtan, Hwaseong-si (KR); HYUNDAI TRANSYS INC., Seosan-si (KR)

(72) Inventors: So Young YOO, Hwaseong-Si (KR); Sang Ho KIM, Hwaseong-Si (KR); Dong Hoon KEUM, Hwaseong-Si (KR); Ji Hwan KIM, Hwaseong-Si (KR); Tae Hoon LEE, Hwaseong-Si (KR); Dong Woo JEONG, Hwaseong-Si (KR); Yoon Min CHOI, Suwon-Si (KR); Gun Young PARK, Incheon (KR); Gyeong Jae LEE, Hwaseong-Si (KR); Hyun KIM, Hwaseong-Si (KR); Il Hwan BAE, Suwon-Si (KR); Sang Min PARK, Yongin-Si (KR); Sang Eon LEE, Suwon-Si (KR)

(73) Assignees: Hyundai Motor Company, Seoul (KR); Kia Corporation, Seoul (KR); Daechang Seat Co.,LTD-Dongtan, Hwaseong-si (KR); HYUNDAI TRANSYS INC., Seosan-si (KR)

(21) Appl. No.: 19/317,423

(22) Filed: Sep. 3, 2025

(30) Foreign Application Priority Data
Feb. 13, 2025 (KR) 10-2025-0018419

(51) Int. Cl. B60R 22/03; B60N 2/68

(52) U.S. Cl. CPC B60R 22/03; B60N 2/688

(57) ABSTRACT

A seat belt feeder includes a housing including a guide slot, and a feeder arm engaged to the guide slot and configured to move along the guide slot. The feeder arm may be configured to perform a curved motion due to the guide slot.

### CROSS-REFERENCE TO RELATED APPLICATION

This application claims, under 35 U.S.C. § 119(a), the benefit of and priority to Korean Patent Application No. 10-2025-0018419, filed on Feb. 13, 2025, the entire contents of which are incorporated herein by reference.

### TECHNICAL FIELD

The present disclosure relates to a seat belt feeder of a vehicle.

### BACKGROUND

A seat belt feeder is a device that assists an occupant in a vehicle in wearing a seat belt. When an occupant sits in a seat and wears a seat belt, the seat belt feeder allows a seatbelt guide to move forward from the side or toward a front of the occupant. In this way, the seat belt feeder may assist the occupant in easily wearing the seat belt without having to excessively rotate the upper body to wear the seat belt.

A conventional seat belt feeder needs a great number of operating components and has a complex assembly process.

The above information included in this Background section is only for enhancement of understanding of the background of the present disclosure, and therefore it may contain information that does not form the related art that is already known to one having ordinary skill in the art.

### SUMMARY

The present disclosure has been made in an effort to solve the above-described problems associated with the related art, and an aspect of the present disclosure is to provide a seat belt feeder that allows an occupant of a seat to easily wear a seat belt.

Another aspect of the present disclosure is to provide a seat belt feeder having a reduced number of components, thus including a simplified structure.

Still another aspect of the present disclosure is to provide a seat belt feeder that is easy to assemble.

Various aspects of the present disclosure are not limited to the foregoing, and other aspects not mentioned herein will be clearly understood by one having ordinary skill in the art to which the present disclosure pertains based on the description below.

The features of the present disclosure to achieve the aspects of the present disclosure as described above and to perform the characteristic functions of the present disclosure to be described later are as follows.

According to some forms of the present disclosure, a seat belt feeder includes a housing including a guide slot, and a feeder arm engaged to the guide slot and configured to move along the guide slot. The feeder arm may be configured to be in a curved motion by the guide slot.

According to some forms of the present disclosure, a seat includes a seat frame, and a seat belt feeder detachably coupled to the seat frame. The seat belt feeder may include a housing including a guide slot, and a feeder arm configured to planarly move along the guide slot.

According to some forms of the present disclosure, a vehicle may include the seat.

Other aspects and various embodiments of the present disclosure are discussed infra.

It is to be understood that the term “vehicle” or “vehicular” or other similar terms as used herein are inclusive of motor vehicles in general, such as passenger automobiles including sports utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given herein below by way of illustration only, and thus are not limitative of the present disclosure, and wherein:

FIG. 1 is a perspective view of a seat belt feeder according to an exemplary embodiment of the present disclosure;

FIG. 2 is an exploded perspective view of a seat belt feeder according to an exemplary embodiment of the present disclosure;

FIG. 3 is a perspective view of a housing of a seat belt feeder according to an exemplary embodiment of the present disclosure;

FIG. 4 is a perspective view of a motor and a lead screw of a seat belt feeder according to an exemplary embodiment of the present disclosure;

FIG. 5A is a perspective view of a carrier of a seat belt feeder according to an exemplary embodiment of the present disclosure;

FIG. 5B is a rear perspective view of a seat belt feeder according to an exemplary embodiment of the present disclosure;

FIG. 6 is a perspective view of a feeder arm of a seat belt feeder according to an exemplary embodiment of the present disclosure;

FIG. 7 is a perspective view of a belt guide of a seat belt feeder according to an exemplary embodiment of the present disclosure;

FIG. 8 illustrates a stowed position of a seat belt feeder according to an exemplary embodiment of the present disclosure;

FIG. 9 illustrates a deployed position of a seat belt feeder according to an exemplary embodiment of the present disclosure;

FIG. 9A, FIG. 9B, FIG. 9C, and FIG. 9D illustrate a seat belt feeder according to an exemplary embodiment of the present disclosure moving from a stowed position to a deployed position;

FIG. 10 illustrates an example of a seat belt feeder according to an exemplary embodiment of the present disclosure being mounted in a seat;

FIG. 11 is an enlarged view of the portion indicated by a dotted line in FIG. 10, illustrating a state before the seat belt feeder according to an exemplary embodiment of the present disclosure is mounted to a seat; and

FIG. 12 is an enlarged view of the portion indicated by a dotted line in FIG. 10, illustrating a state in which the seat belt feeder according to an exemplary embodiment of the present disclosure is mounted to a seat.

It should be understood that the appended drawings are not necessarily to scale, presenting a somewhat simplified representation of various features illustrative of the basic principles of the present disclosure. The specific design features of the present disclosure, including, for example, specific dimensions, orientations, locations, and shapes, will be determined in part by the particular intended application and usage environment.

In the figures, the reference numerals refer to the same or equivalent parts of the present disclosure throughout the several figures of the drawing.

### DETAILED DESCRIPTION

Descriptions of predetermined structures or functions presented in the exemplary embodiments of the present disclosure are merely exemplary for the purpose of explaining the exemplary embodiments according to the concept of the present disclosure, and the exemplary embodiments according to the concept of the present disclosure may be implemented in various forms. In addition, the descriptions should not be construed as being limited to the exemplary embodiments described herein, and should be understood to include all modifications, equivalents and substitutes falling within the idea and scope of the present disclosure.

Meanwhile, in the present disclosure, terms such as “first” and/or “second” may be used to describe various components, but the components are not limited by the terms. These terms are only used to distinguish one component from another. For example, a first component could be termed a second component, and similarly, a second component could be termed a first component, without departing from the scope of exemplary embodiments of the present disclosure.

It will be understood that, when a component is referred to as being “connected to” or “brought into contact with” another component, the component may be directly connected to or brought into contact with the other component, or intervening components may also be present. In contrast, when a component is referred to as being “directly connected to” or “brought into direct contact with” another component, there is no intervening component present. Other terms used to describe relationships between components should be interpreted in a like fashion (e.g., “between” versus “directly between,” “adjacent” versus “directly adjacent,” etc.).

Throughout the specification, like reference numerals indicate like components. The terminology used herein is for the purpose of illustrating embodiments and is not intended to limit the present disclosure. In this specification, the singular form includes the plural sense, unless specified otherwise. The terms “comprises” and/or “comprising” used in this specification mean that the cited component, step, operation, and/or element does not exclude the presence or addition of one or more of other components, steps, operations, and/or elements.

Hereinafter, the present disclosure is described in detail with reference to the accompanying drawings.

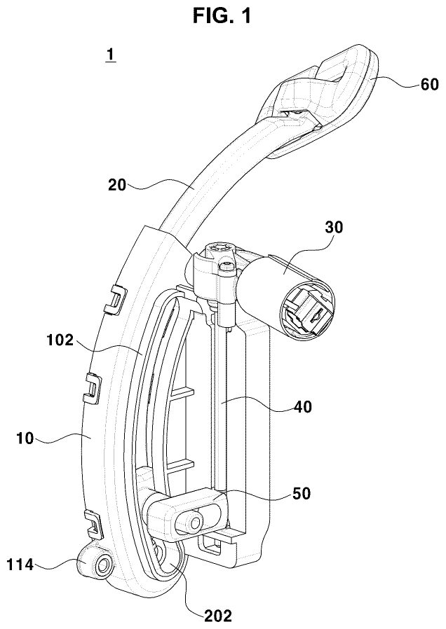

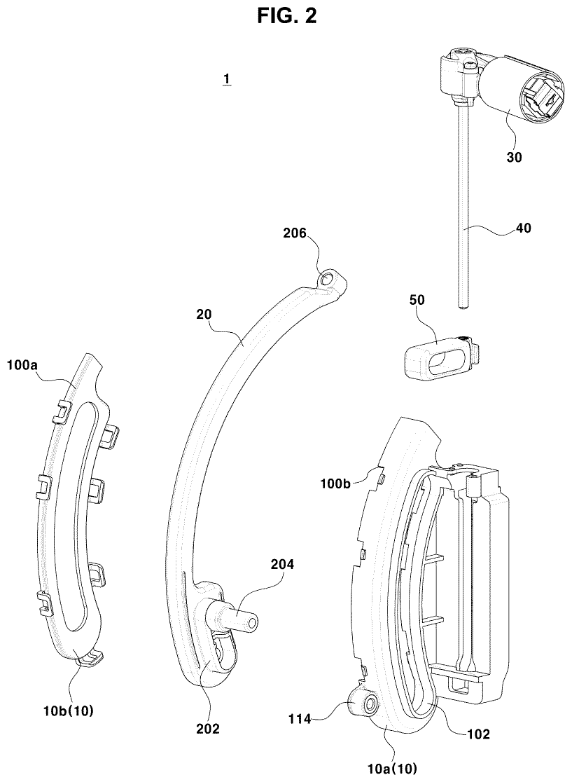

As illustrated in FIGS. 1 and 2, according to an exemplary embodiment of the present disclosure, a seat belt feeder 1 may include a housing 10 and a feeder arm 20. The feeder arm 20 is configured to move relative to the housing 10. In an exemplary embodiment of the present disclosure, the feeder arm 20 is configured to be drawn into or drawn out from the housing 10. In some embodiments, the feeder arm 20 may be forwardly drawn out from the housing 10 and may be, from the state of being drawn out, introduced backward into the housing 10. In some embodiments, the feeder arm 20 may be raised relative to the housing 10 as being drawn out from the housing 10 and may be lowered relative to the housing 10 as returning from the raised state.

The feeder arm 20 may be operatively coupled to the housing 10 to move relative to the housing 10 or to move along the housing 10. The housing 10 may be configured to be disassembled. In an exemplary embodiment of the present disclosure, the housing 10 may include a first housing 10a and a second housing 10b. The first housing 10a and the second housing 10b may be detachably coupled to each other. The feeder arm 20 may be disposed between the first housing 10a and the second housing 10b, and the first housing 10a and the second housing 10b may be coupled to each other. In an exemplary embodiment of the present disclosure, a hook 100a of the second housing 10b is configured to engage with a catch 100b of the first housing 10a, allowing the first housing 10a and the second housing 10b to be detachably coupled to each other.

In an exemplary embodiment of the present disclosure, the housing 10 may include a guide slot 102. Moreover, the feeder arm 20 may include a mount portion 202 mounted to the guide slot 102. The mount portion 202 is configured to be inserted into the guide slot 102 and to move along the guide slot 102. In an exemplary embodiment of the present disclosure, the guide slot 102 may include a curved surface portion. For example, the guide slot 102 may include a generally arc shape.

The seat belt feeder 1 may further include an actuator. The feeder arm 20 may move relative to the housing 10 by the actuator. In an exemplary embodiment of the present disclosure, the actuator may include a motor 30. The motor 30 is configured to receive power from a power source. Moreover, the motor 30 is configured to be controllable. The motor 30 may be controlled so that the shaft of the motor 30 is controlled to rotate in one of a first rotational direction (e.g., clockwise) or a second rotational direction (e.g., counterclockwise) opposite the first rotational direction.

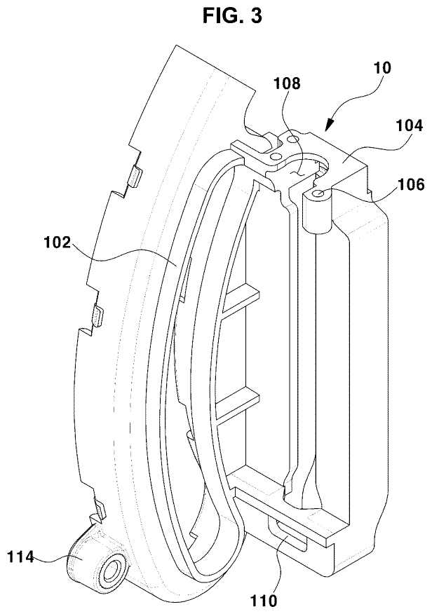

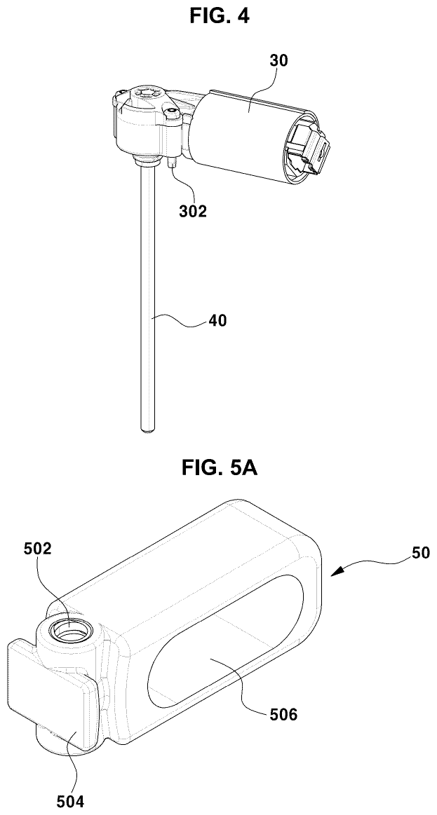

Referring additionally to FIGS. 3 and 4, the motor 30 may be operatively connected to the housing 10. In an exemplary embodiment of the present disclosure, the housing 10 may include a seating portion 104. The seating portion 104 is configured to support the motor 30. In an exemplary embodiment of the present disclosure, the seating portion 104 may include a plurality of insertion holes 106. The insertion holes 106 are configured so that insertion projections 302 formed on the motor 30 are inserted into the insertion holes 106, respectively. As a non-limiting example, the insertion hole 106 and the insertion projection 302 may be coupled to each other through a fitting connection. For example, the fitting connection may include a snap fit or a pressure fit.

A linear guide may be mounted to the motor 30. In an exemplary embodiment of the present disclosure, a lead screw 40 may be mounted to the motor 30. The lead screw 40 is configured to rotate by a rotation of the motor 30. The rotation force of the motor 30 may be transferred to the feeder arm 20 through the lead screw 40. In an exemplary embodiment of the present disclosure, the housing 10 may include a recess 108. In an exemplary embodiment of the present disclosure, the recess 108 is configured to extend along the housing 10 from the seating portion 104. The recess 108 is configured to rotatably receive the lead screw 40. Moreover, the housing 10 may include a support portion 110. The support portion 110 may rotatably support a free end portion of the lead screw 40. The free end portion of the lead screw 40 passing through the recess 108 may be rotatably fixed by the support portion 110.

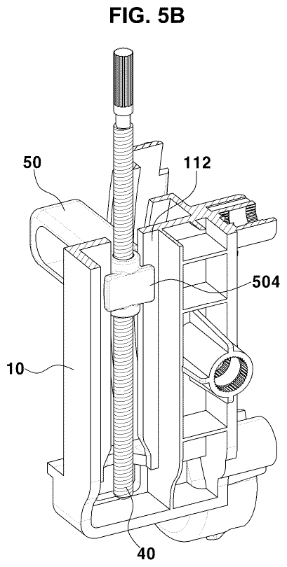

Referring additionally to FIG. 5A, the seat belt feeder 1 may further include a carrier 50. The rotation forces of the motor 30 and the lead screw 40 may be transferred to the feeder arm 20 through the carrier 50. The carrier 50 may be operatively mounted to the lead screw 40. In an exemplary embodiment of the present disclosure, the carrier 50 may include a threaded hole 502. The lead screw 40 may be inserted into the threaded hole 502. Accordingly, when the lead screw 40 rotates, the carrier 50 is configured to move along the lead screw 40. In response to rotation of the lead screw 40 in the first rotational direction, the carrier 50 may move in a first linear direction. In response to rotation of the lead screw 40 in the second rotational direction, the carrier 50 may move in a second linear direction. The second linear direction may be opposite to the first linear direction.

In an exemplary embodiment of the present disclosure, the carrier 50 may include a guide 504. The guide 504 is configured to guide the movement of the carrier 50 relative to the housing 10. The guide 504 may move along a track 112 formed in the housing 10. As illustrated in FIG. 5B, the track 112 may be formed in the housing 10, adjacent to the recess 108, and may extend in a longitudinal direction of the housing 10.

According to some embodiments, the carrier 50 may include one guide 504. The one guide 504 may move along a track 112 provided in the housing 10. According to some embodiments, a pair of guides 504 may be provided in the carrier 50. The pair of guides 504 each may be guided to move along a corresponding one of tracks 112 provided in the housing 10.

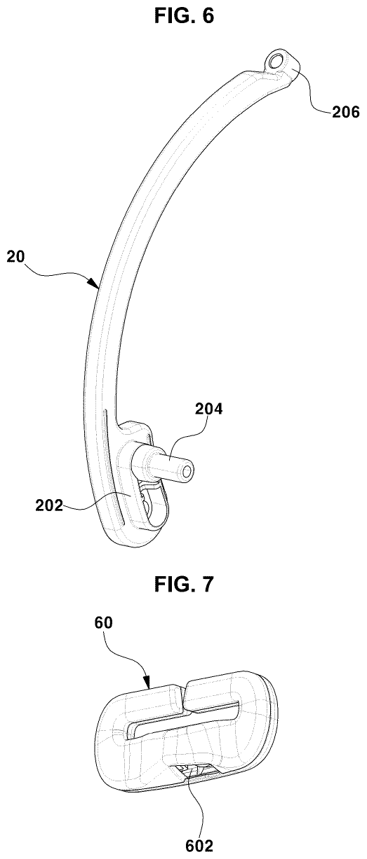

The carrier 50 is configured to transfer the rotation forces of the motor 30 and the lead screw 40 to the feeder arm 20 to move the feeder arm 20. In an exemplary embodiment of the present disclosure, the feeder arm 20 may be operatively coupled to the carrier 50. In an exemplary embodiment of the present disclosure, the carrier 50 may include a slot 506. Referring to FIG. 6, the feeder arm 20 may include a cantilever 204. The cantilever 204 is configured to be inserted into the slot 506 and to move along the slot 506. The movement of the feeder arm 20 may be guided by the slot 506 and the guide slot 102.

According to an exemplary embodiment of the present disclosure, the feeder arm 20 may be configured to generally face a direction perpendicular to the longitudinal direction of the housing 10. Such a shape may facilitate in moving the feeder arm 20 to the front of the occupant of the vehicle.

Referring to FIG. 7, a belt guide 60 may be mounted on the feeder arm 20. A seat belt may be inserted into the belt guide 60. In an exemplary embodiment of the present disclosure, the feeder arm 20 may include a coupling portion 206. The coupling portion 206 may be provided at a distal end portion of the feeder arm 20. An engaging portion 602 may be formed in the belt guide 60, and the engaging portion 602 may be coupled to the coupling portion 206.

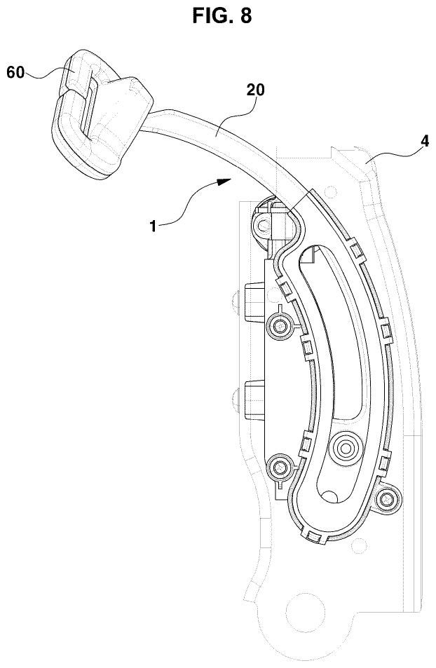

As illustrated in FIG. 8, the seat belt feeder 1 may include a stowed position. In the stowed position of the seat belt feeder 1, the mount portion 202 of the feeder arm 20 may be positioned at a first position in the guide slot 102. In the illustrated embodiment, the first position may be a lowermost position in the guide slot 102.

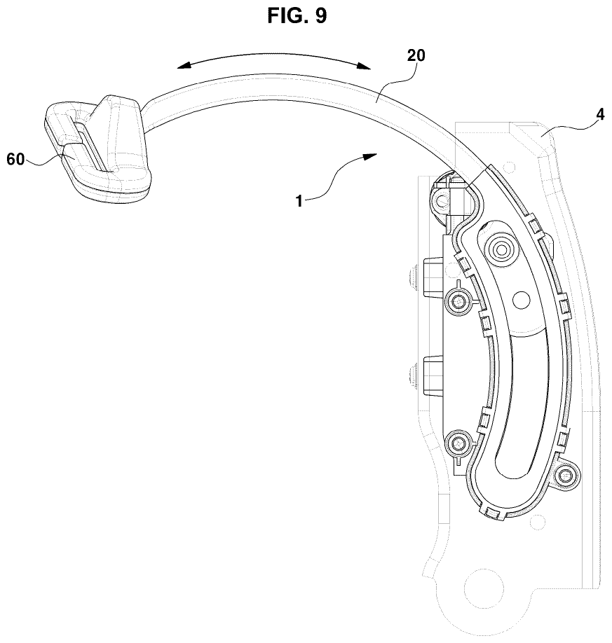

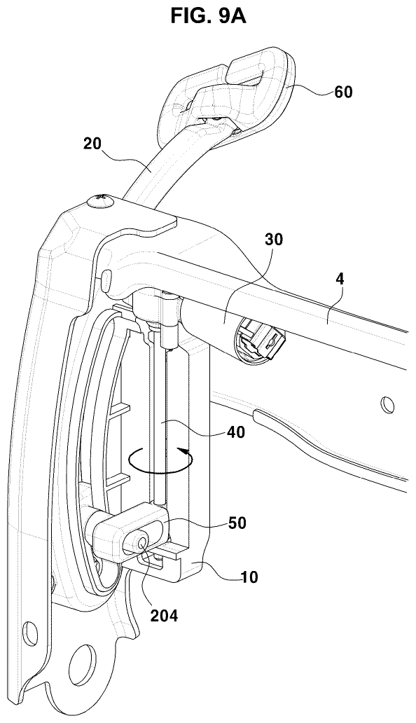

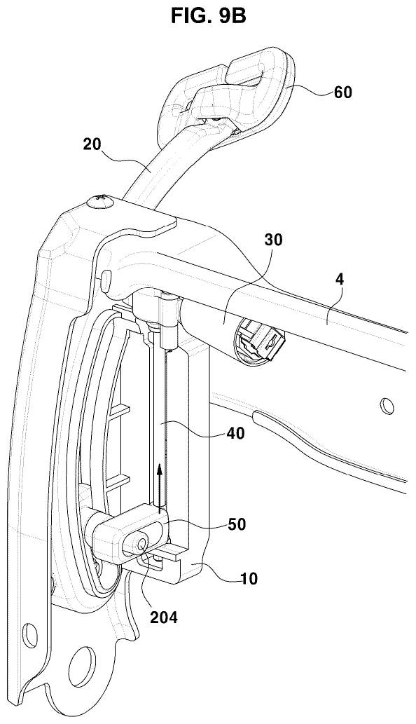

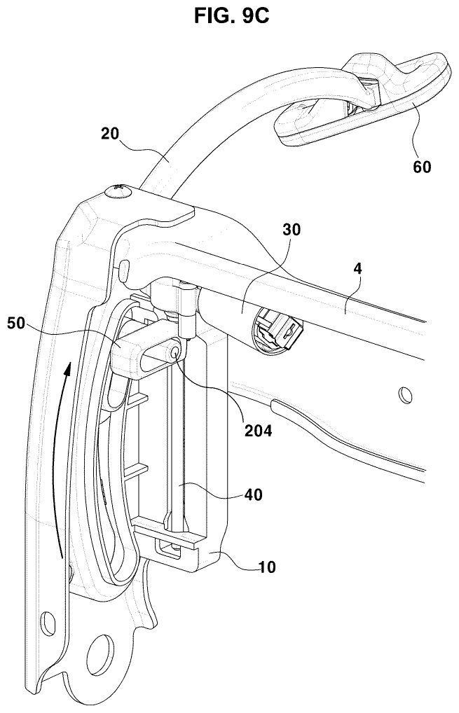

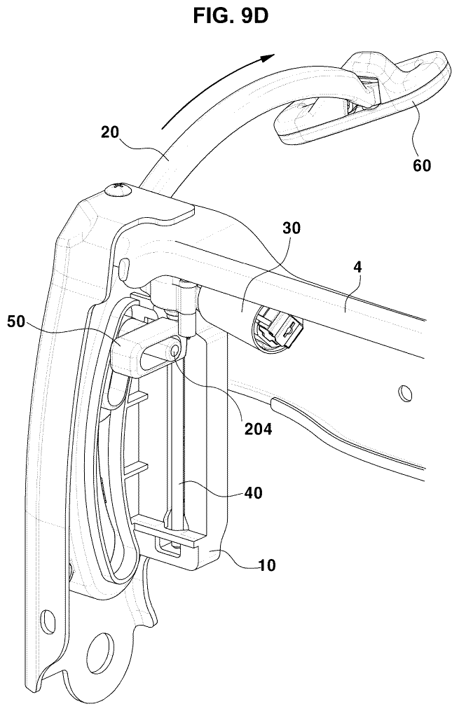

As illustrated in FIG. 9, the seat belt feeder 1 may include a deployed position. By operating the seat belt feeder 1, the seat belt feeder 1 may be positioned in the stowed position or in the deployed position. Moreover, by operating the seat belt feeder 1, the seat belt feeder 1 may move between the stowed position and the deployed position. In the deployed position of the seat belt feeder 1, the mount portion 202 of the feeder arm 20 may be positioned in a second position in the guide slot 102. In the illustrated embodiment, the second position may be an uppermost position in the guide slot 102.

Referring to FIG. 9A, FIG. 9B, FIG. 9C, and FIG. 9D, the seat belt feeder 1 may be drawn out through the following operation.

As illustrated in FIG. 9A, the seat belt feeder 1 in the stowed position starts to operate. When the motor 30 is rotated in the first rotational direction at the stowed position of the seat belt feeder 1, the lead screw 40 connected to the motor 30 is rotated.

As illustrated in FIG. 9B, the carrier 50 is configured to move along the lead screw 40 in the first linear direction by the rotation of the lead screw 40. In the illustrated embodiment, the first linear direction may be described as being raised along the housing 10. Here, during the carrier 50 moving along a portion of the guide slot 102 that is convex in the opposite direction to the lead screw 40, the cantilever 204 may move away from the lead screw 40 in the slot 506 due to the shape of the guide slot 102. During the present movement, the cantilever 204 is configured to linearly move, and the feeder arm 20 is configured to move upward as a whole.

When the cantilever 204 is restricted from moving away from the lead screw 40 due to the slot 506, the cantilever 204 is, as illustrated in FIG. 9C, configured to be in a curved motion along the curved shape of the guide slot 102 and to move toward the lead screw 40 in the slot 506. The curved motion of the feeder arm 20 may allow the feeder arm 20 to move upward with respect to the housing 10 and forward, as illustrated in FIG. 9D.

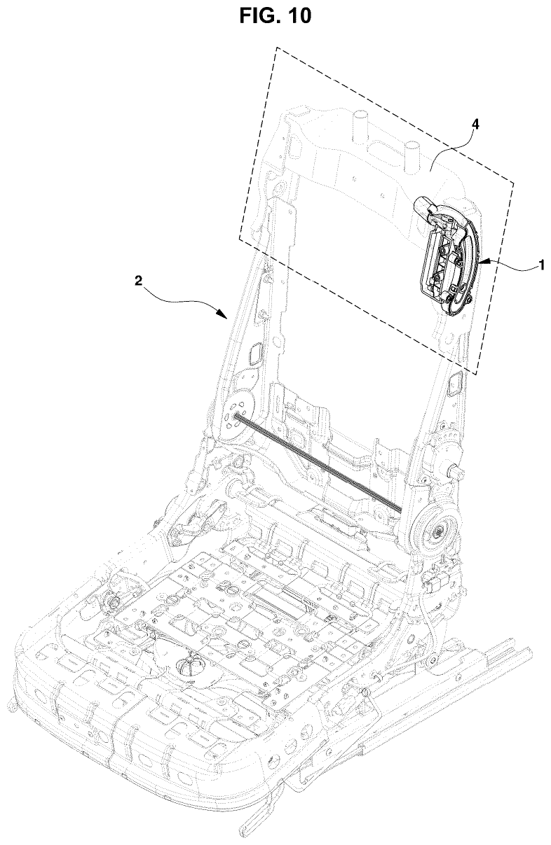

Referring to FIG. 10, according to an exemplary embodiment of the present disclosure, the seat belt feeder 1 may be mounted to a seat 2 of the vehicle. In an exemplary embodiment of the present disclosure, the seat belt feeder 1 may be mounted to a back frame 4 of the seat 2 of the vehicle.

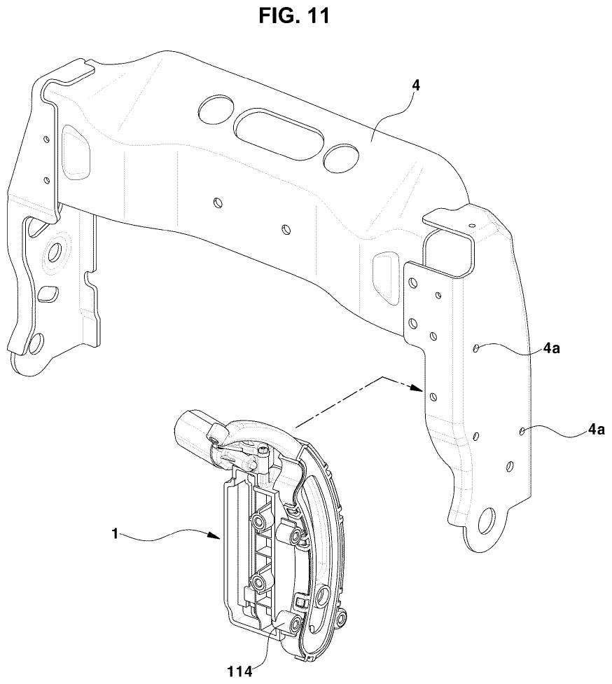

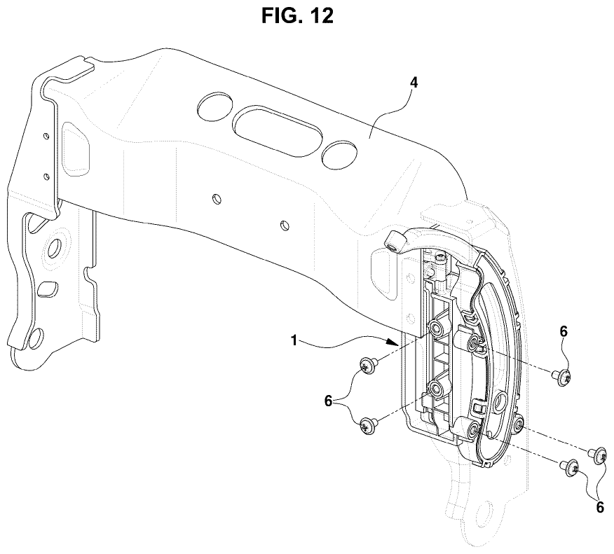

As illustrated in FIGS. 11 and 12, the seat belt feeder 1 may be modularized. In an exemplary embodiment of the present disclosure, the housing 10 may include a fastening portion 114, and the back frame 4 may include a fastening hole 4a. By a fastening member 6 passing through the fastening hole 4a and being coupled to the fastening portion 114, the seat belt feeder 1 may be mounted to the back frame 4. In an example, the fastening member 6 may include a bolt. The seat belt feeder 1 may be detached from the back frame 4 by disassembling the fastening member 6.

Accordingly, the seat belt feeder according to the present disclosure is modularized, facilitating assembly and maintenance.

Moreover, the seat belt feeder according to the present disclosure includes a reduced number of components compared to the related art, simplifying the structure and reducing material costs.

Furthermore, the seat belt feeder according to the present disclosure may reduce vibration by being fixed in the up-down, left-right, and front-back directions. For example, the housing of the seat belt feeder restricts the up-down movement of the carrier and the circular trajectory of the feeder arm with two axes, easily reducing the gap or vibration in the entire feeder.

As is apparent from the above description, the present disclosure provides the following effects.

According to the present disclosure, a seat belt feeder that allows an occupant of a seat to easily wear a seat belt is provided.

According to the present disclosure, a seat belt feeder having a reduced number of components and thus being capable of including a simplified structure and reducing material costs is provided.

According to the present disclosure, a seat belt feeder that facilitates assembly and maintenance is provided.

Effects of the present disclosure are not limited to what has been described above, and other effects not mentioned herein will be clearly recognized by those skilled in the art based on the above description.

It will be apparent to those of ordinary skill in the art to which the present disclosure pertains that the present disclosure described above is not limited by the above-described embodiments and the accompanying drawings, and various substitutions, modifications and changes are possible within a range that does not depart from the technical idea of the present disclosure.

What is claimed is:

1. A seat belt feeder, comprising:
a housing comprising a guide slot; and
a feeder arm engaged to the guide slot and configured to move along the guide slot,
wherein the feeder arm is configured to be in a curved motion by the guide slot.

2. The seat belt feeder of claim 1, wherein the feeder arm comprises a cantilever inserted into the guide slot and configured to move along the guide slot.

3. The seat belt feeder of claim 2, further comprising:
a carrier configured to linearly move with respect to the housing,
wherein the cantilever is configured to move together with the carrier.

4. The seat belt feeder of claim 3,
wherein the carrier comprises a slot, wherein the cantilever is inserted into the slot, and
wherein the cantilever is configured to move along the slot.

5. The seat belt feeder of claim 3, further comprising:
a lead screw, wherein the carrier is mounted to the lead screw; and
a motor connected to the lead screw and configured to provide a rotational force to the lead screw.

6. The seat belt feeder of claim 5,
wherein the carrier comprises a threaded hole, wherein a screw thread is formed in the threaded hole, and
wherein the lead screw is inserted into the threaded hole and engaged thereto.

7. The seat belt feeder of claim 5,
wherein the motor comprises an insertion projection, and
wherein the housing comprises an insertion hole, wherein the insertion projection is inserted into the insertion hole.

8. The seat belt feeder of claim 5, wherein the housing comprises a recess extending along the housing, and the lead screw is placed in the recess.

9. The seat belt feeder of claim 3, wherein the carrier comprises a guide configured to be guided by the housing.

10. The seat belt feeder of claim 1, wherein a belt guide is connected to the feeder arm.

11. A seat, comprising:
a seat frame; and
a seat belt feeder detachably coupled to the seat frame,
wherein the seat belt feeder comprises:
a housing comprising a guide slot; and
a feeder arm engaged to the guide slot and configured to planarly move along the guide slot.

12. The seat of claim 11, wherein the guide slot comprises a curved portion.

13. The seat of claim 11, wherein the feeder arm comprises a cantilever inserted into the guide slot and configured to move along the guide slot.

14. The seat of claim 13,
wherein the seat belt feeder further comprises a carrier configured to linearly move with respect to the housing, and
wherein the cantilever is configured to move together with the carrier.

15. The seat of claim 14,
wherein the carrier comprises a slot, wherein the cantilever is inserted into the slot, and
wherein the cantilever is configured to move along the slot.

16. The seat of claim 14, wherein the seat belt feeder further comprises:
a lead screw, wherein the carrier is mounted to the lead screw; and
a motor connected to the lead screw and configured to provide a rotational force to the lead screw.

17. The seat of claim 11, wherein the housing comprises:
a first housing; and
a second housing detachably coupled to the first housing, and
wherein the feeder arm is held between the first housing and the second housing.

18. The seat of claim 17, comprising:
a catch formed in the first housing; and
a hook formed on the second housing and being connectable to the catch.

19. The seat of claim 11, wherein a belt guide is connected to the feeder arm.

20. A vehicle comprising the seat of claim 11.
